(19) United States
(12) Patent Application Publication
(10) Pub. No.: US 2008/0302198 A1
(43) Pub. Date: Dec. 11, 2008

(54) Resin gear

(75) Inventor: Toru Takumori, Kawaguchi-shi (JP)

Correspondence Address: Quin Emanuel Urquhart Oliver & Hedges, LLP;Koda/Androlia, 10th Floor, 865 S. Figueroa Street, Los Angeles, CA, 90017, US

(73) Assignee: Enplas Corporation

(21) Appl. No.: 12/077,347

(22) Filed: Mar. 19, 2008

(30) Foreign Application Priority Data
Mar. 27, 2007 (JP) 2007-081568

(51) Int. Cl. F16H 55/08

(52) U.S. Cl. 74/457

(57) ABSTRACT

In a resin gear formed such that a first teeth section formed into a spiral and a second teeth section formed into a spiral having an opposite twist direction from the first teeth section are joined at a tooth width direction center section, reductions in quietness and smoothness caused by a decrease in contact ratio can be suppressed.

A diameter D1 of a pitch-circle of a first teeth section 10 and a diameter D2 of a pitch-circle of a second teeth section are the same. A module m1 of the first teeth section 10 is an integral multiple (for example, double) of a module m2 of the second teeth section 20. Contact ratio can be enhanced by the module m2 of the second teeth section 20 being made smaller.

### BACKGROUND OF THE INVENTION

1. Field of the Invention

The present invention relates to a resin gear including two tooth sections that twist in opposite horizontal directions and have different modules.

2. Description of the Related Art

Conventionally, a resin helical gear is widely used as a power transmission mechanism in automobile components, precision machinery, various electronic devices, and the like, in addition to office equipment, such as copiers, printers, and facsimile machines. This is because the resin helical gear has the following advantages attributed a structural characteristic of the resin helical gear in that teeth of the resin helical gear are twisted. The advantages are that power transmission can be performed quietly because meshing is smooth even during high-speed rotation, and a high-load power transmission can be performed because load can be easily dispersed along a tooth trace.

At the same time, the resin helical gear has a following disadvantage because the teeth are twisted. In other words, an axial-direction thrust load proportional to a transmission torque is generated during power transmission. Therefore, a structure for receiving the thrust load is required. To resolve this disadvantage, a configuration in which the thrust load is received by a thrust bearing can be considered. However, in actuality, it may not be possible to dispose the thrust bearing because of spatial constraints and structural constraints of the power transmission mechanism.

Therefore, a technology has been developed for forming a following resin double-helical gear by injection-molding. Like the resin helical gear disclosed in Patent Literature 1, the resin double-helical gear is quiet and capable of performing high-speed and high-load power transmission. Moreover, unlike the resin helical gear, the thrust load is not generated in the resin double-helical gear during power transmission (refer to Patent Literature 1).

At the same time, in Patent Literature 2, a technology is disclosed for forming a single gear by joining two spur gears having a same pitch-circle diameter and different modules.

Patent Literature 1: Japanese Patent Laid-open Publication No. Heisei 10-315344

Patent Literature 2: Japanese Patent Laid-open Publication No. 2002-147543

However, in Patent Literature 1, although the thrust load can be eliminated in the double-helical gear, contact ratio decreases compared to a helical gear that has the same overall tooth width and twist angle. Therefore, quietness and smoothness (minimal uneven rotation) are also poorer compared to the helical gear. In other words, when the contact ratio of the helical gear is e, a contact ratio of a spur gear relative to a front tooth profile is ea, and an overlap ratio is eβ,

e=eₐ+e_{β}

When, in the overlap ratio eβ, a twist angle is β, a tooth width is b, a module perpendicular to an axis is m,

e_{β}=b tan β/pm

Here, the double-helical gear having the same overall tooth width b and the same twist angle β as the helical gear is formed such that both end sides of the tooth are symmetrical, with the tooth width direction center section as a reference point. Therefore, when the overlap ratio is calculated, the tooth width is considered to be b/2. Therefore, the contact ratio e0 of the double-helical gear is expressed by

e0=eₐ+(b/2)·tan β/pm

The contact ratio of the double-helical gear becomes smaller than the contact ratio e of the helical gear by (b/2)·tan β/pm. The quietness and smoothness deteriorates by this amount.

At the same time, the gear in Patent Literature 2 is a spur gear. Therefore, structurally, the spur gear has disadvantages such as being weaker, being louder, and vibrating more than the helical gear.

### SUMMARY OF THE INVENTION

Therefore, an object of the present invention is to provide a resin gear that does not generate thrust load, suppresses reduction in contact ratio relative to a helical gear, and is superior to a double-helical gear in quietness and smoothness.

The invention according to claim 1 is related to a resin gear. The resin gear includes a first teeth section formed into a spiral and a second teeth section formed into a spiral having an opposite twist direction from the first teeth section. In the resin gear of the invention, a diameter of a pitch-circle of the first teeth section and a diameter of a pitch-circle of the second teeth section are the same. A module of the first teeth section and a module of a second teeth section differ.

The invention according to claim 2 is the resin gear according to claim 1, in which the module of the first teeth section is an integral multiple of the module of the second teeth section.

The invention according to claim 3 is the resin gear according to claim 2, in which a position in a circumferential direction of a center in a tooth thickness direction on an end surface positioned on the tooth width direction center section side, between two end surfaces of a tooth of the first teeth section, matches a position in a circumferential direction of a center in a tooth thickness direction on an end surface positioned on the tooth width direction center section side, between two end surfaces of a tooth of the second teeth section.

The invention according to claim 4 is the resin gear according to claim 3, in which the module of the first teeth section is an even number multiple of the module of the second teeth section.

The invention according to claim 5 is the resin gear according to claim 3, in which the module of the first teeth section is an odd number multiple of the module of the second teeth section.

The invention according to claim 6 is the resin gear according to any one of claims 1 to 5, in which the end surface on the tooth width direction center section side of the tooth of the first teeth section and the end surface on the tooth width direction center section side of the tooth of the second teeth section are on a same plane.

The invention according to claim 7 is the resin gear according to any one of claims 1 to 5, in which the end surface on the tooth width direction center section side of the tooth of the first teeth section and the end surface on the tooth width direction center section side of the tooth of the second teeth section are each in different positions in the tooth width direction and on two different planes perpendicular in the tooth width direction.

The invention according to claim 8 is the resin gear according to any one of claims 1 to 7, in which the tooth width of the tooth of the first teeth section and the tooth width of the tooth of the second teeth section differ.

### EFFECT OF THE INVENTION

In the invention according to claim 1 the module of the first teeth section and the module of a second teeth section differ. Therefore, compared to when the first teeth section and the second teeth section both include the larger of the two modules, the contact ratio can be increased. As a result, the reductions in quietness and smoothness caused by the small contact ratio can be suppressed. At the same time, compared to when the first teeth section and the second teeth section both include the smaller of the two modules, a larger load can be applied. Because the number of teeth in the first teeth section and the number of teeth in the second teeth section differ, in terms of a single rotation, variations in uneven rotation can be suppressed.

In the invention according to claim 2, the module of the first teeth section is an integral multiple of the module of the second teeth section. Therefore, as a result of the phases in the circumferential direction of the first teeth section and the second teeth section being adjusted, the thrust load generated in the first teeth section and the thrust load generated in the second teeth section can be canceled.

In the invention according to claim 3, at least one or more teeth of the second teeth section including the smaller module can be disposed between two adjacent teeth of the first teeth section including the larger module. In addition, the variations in uneven rotation can be suppressed in terms of a single pitch of the first teeth section including the larger module. Therefore, the variations in uneven rotation in terms of a single rotation can be further suppressed.

In the invention according to claim 4, an odd number of teeth of the second teeth section including the smaller module can be disposed between two adjacent teeth of the first teeth section including the larger module.

In the invention according to claim 5 is the resin gear according to claim 3, an even number of two or more teeth of the second teeth section including the smaller module can be disposed between two adjacent teeth of the first teeth section including the larger module.

In the invention according to claim 6, a gap is not formed between the end surface on the tooth width direction center section side of the tooth of the first teeth section and the end surface on the tooth width direction center section side of the tooth of the second teeth section. Therefore, dimensions in the tooth width direction can be shortened.

In the invention according to claim 7, a gap is formed between the end surface on the tooth width direction center section side of the tooth of the first teeth section and the end surface on the tooth width direction center section side of the tooth of the second teeth section. Therefore, for example, meshing can be performed even when a similar gap is not formed in a meshing mating resin gear. In addition, for example, when the gap is not formed between the first teeth section and the second teeth section, misalignment or unevenness may occur near the tooth width direction center section when the resin gear is made using an injection-molding mold in which two molds are butted against each other near the tooth width direction center section. As a result of the gap described above being formed, effects of a tooth trace direction error during gear meshing can be suppressed even when the misalignment and unevenness occur.

In the invention according to claim 8, the tooth width of the tooth of the first teeth section and the tooth width of the tooth of the second teeth section differ. Therefore, for example, when a high-load power transmission is to be performed, the tooth width of the teeth of the first tooth section including the larger module can be increased. At the same time, when quietness and smoothness are to be further enhanced, the tooth width of the teeth of the second tooth section including the smaller module can be increased.

### BRIEF DESCRIPTION OF THE DRAWINGS

FIG. 1 is diagrams of a resin gear according to a first embodiment; FIG. 1(a) is a front view of the resin gear viewed from a first teeth section side; FIG. 1(b) is a side view of the resin gear of which an upper half is broken; FIG. 1(c) is a rear view of the resin gear;

FIG. 2 is a partially enlarged perspective view of a tooth of the resin gear according to the first embodiment;

FIG. 3 is a side view of when two resin gears according to the first embodiment mesh;

FIG. 4 is a schematic diagram of a tooth of a resin gear according to a second embodiment viewed from a rear side;

FIG. 5 is a side view of a resin gear according to a third embodiment; and

FIG. 6 is a side view of a resin gear according to a fourth embodiment.

### DETAILED DESCRIPTION OF THE PREFERRED EMBODIMENT

Embodiments of the present invention will be described in detail, below, with reference to the drawings.

### First Embodiment

Embodiments of the present invention will be described in detail, below, with reference to the drawings.

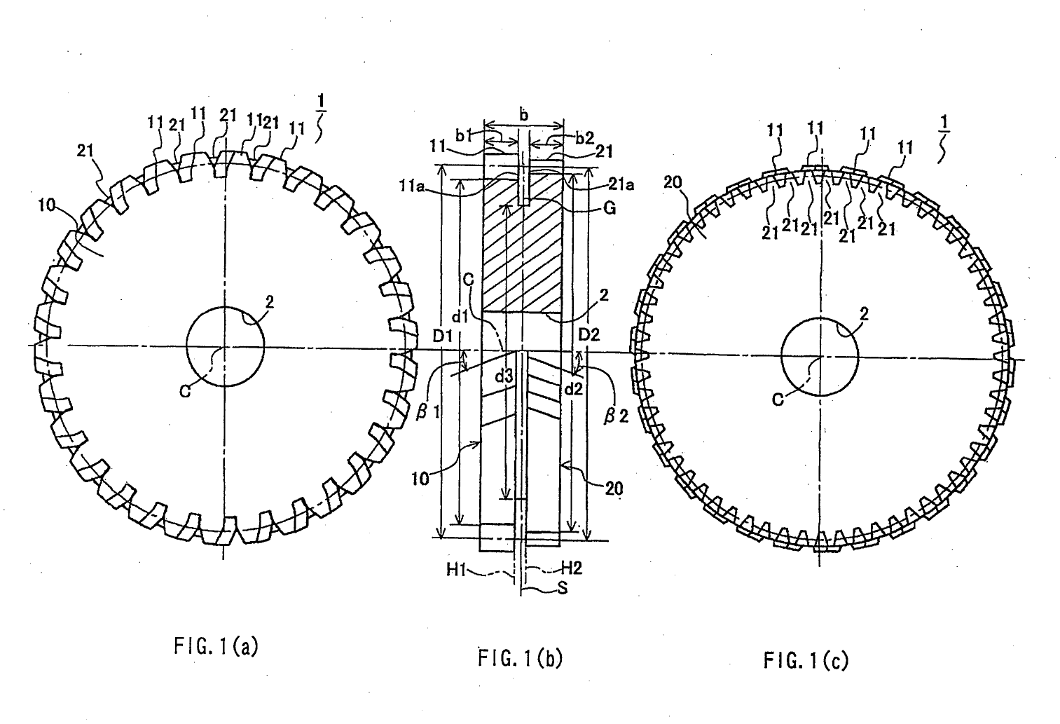

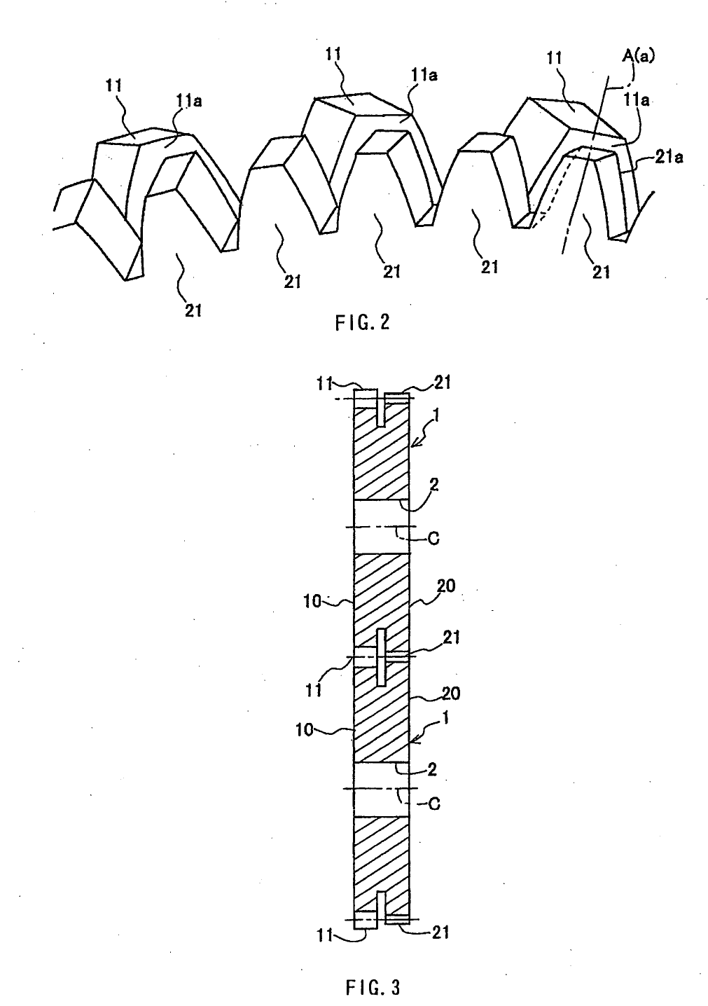

A resin gear 1 of the invention will be described with reference to FIG. 1 to FIG. 3. FIG. 1(a) is a front view of the resin gear 1 viewed from a first teeth section 10 side. FIG. 1(b) is a side view of the resin gear 1 of which an upper half is broken. FIG. 1(c) is a rear view of the resin gear 1 or, in other words, a front view of the resin gear 1 viewed from a second teeth section 20 side. FIG. 2 is a perspective view of some of a plurality of teeth 11 and teeth 21 of the resin gear 1. FIG. 3 is a side view of when two resin gears 1 of the invention mesh.

As shown in the diagrams, the resin gear 1 is shaped such that two helical gears with opposite horizontal twist directions are adhered together. In other words, the resin double-helical gear 1 includes a first teeth section 10 with a leftward twist and a second teeth section 20 with a rightward twist. The first teeth section 10 and the second teeth section 20 are joined at a tooth width direction center section S (see FIG. 1(b)). An axis hole 2 is provided in the center of the resin gear 1 such as to pass through the resin gear 1 along an axis C.

Here, regarding a tooth 11 of the first teeth section 10, a diameter of a pitch-circle is D1. A diameter of a bottom land circle is d1. A module is m1. A tooth width is b1. A twist angle is β1. Similarly, regarding a tooth 21 of the second teeth section 20, the diameter of the pitch-circle is D2. The diameter of the bottom land circle is d2. The module is m2. The tooth width is b2. The twist angle is β2.

Following conditions are further set in the invention for each value described above.

(1) D1 and D2 are equal (D1=D2). In other words, the diameter D1 of the pitch-circle of the first teeth section 10 and the diameter D2 of the pitch-circle of the second teeth section 20 are the same. This is because the invention aims to solve problems of a commonly-shaped resin double-helical gear. In the commonly-shaped resin double-helical gear, when the resin double-helical gear is considered to be a combination of two helical gears having opposite twist directions, the diameter of the pitch-circle of each helical gear is equal. However, in principle, the diameter D1 of the pitch-circle of the first teeth section 10 and the diameter D2 of the pitch-circle of the second teeth section 20 are not necessarily required to be the same. Advantages of the diameters of the pitch-circles being the same are as follows. For example, accuracy in manufacturing can be ensured, and meshing accuracy when the resin double-helical gear meshes with a mating resin double-helical gear can be ensured.

(2) m1 is greater than m2 (m1>m2). In other words, the module m1 of the first teeth section 10 is formed to be larger than the module m2 of the second teeth section 20 (the opposite is also possible). Compared to when both the first teeth section 10 and the second teeth section 20 include the larger module m1, an overall contact ratio of the resin gear 1 can be increased as a result of one module being m2 that is smaller than m1. Therefore, reductions in quietness and smoothness caused by a low contact ratio can be suppressed. At the same time, compared to when both the first teeth section 10 and the second teeth section 20 include the smaller module m2, there is an advantage in that a large load can be applied.

In addition to the above-described conditions of the invention, following conditions according to the embodiment are added.

(3) m1 and nm2 are equal (where n is a natural number that is 2 or greater) (m1=nm2). In other words, the module m1 of the first teeth section 10 is an integral multiple (excluding 1) of the module m2 of the second teeth section 20. A variation cycle of the thrust load when the first teeth section 10 alone is considered is an integral multiple of a variation cycle of the thrust load when the second teeth section 20 alone is considered. Therefore, as a result of the circumferential direction phase of the first teeth section 10 and the second teeth section 20 being adjusted, respective thrust loads can be more easily cancelled compared to when the variation cycle is not an integral multiple.

(4) A position in a circumferential direction of a center A in a tooth thickness direction on an end surface 11a positioned on the tooth width direction center section side, between two end surfaces of the tooth 11 of the first teeth section 10, matches a position in a circumferential direction of a center a in a tooth thickness direction on an end surface 21a positioned on the tooth width direction center section S side, between two end surfaces of the tooth 21 of the second teeth section 20. This regulates the circumferential direction phase of the first teeth section 10 and the second teeth section 20. According to the regulation, in combination with (3), above, at least one or more teeth 21 of the second teeth section 20 including the small module m2 can be disposed between two adjacent teeth 11 and 11 of the first teeth section 10 including the large module m1.

(5) n in (3), above, is an even number. As a result, the tooth 21 of the second teeth section 20 can be disposed in the middle of the two adjacent teeth 11 of the first teeth section 10. Therefore, the tooth 21 of the second teeth section 20 can suppress uneven rotation in the middle of the two adjacent teeth 11 of the first teeth section 10, at which uneven rotation most often occurs.

(6) b1 and b2 are equal (b1=b2). The tooth width b1 of the tooth 11 of the first teeth section 10 and the tooth width b2 of the tooth 21 of the second teeth section 20 are the same.

(7) A ring-shaped slit G is provided on an outer circumferential side of the tooth width direction center section S of the resin gear 1. In other words, the end surface 11a on the tooth width direction center section side of the tooth 11 of the first teeth section 10 and the end surface 21a on the tooth width direction center section side of the tooth 21 of the second teeth section 20 are each positioned at different positions in the tooth width direction and on two different virtual planes H1 and H2 that are perpendicular in the tooth width direction. The slit G is formed such that a diameter d3 of the slit G is smaller than the diameter d1 of the bottom land circle of the first teeth section 10 and the diameter d2 of the bottom land circle of the second teeth section 20. As a result of the slit G being provided, even when the mating resin gear meshing with the resin gear 1 does not have a slit such as this, two resin gears can be successfully meshed. Both of the two meshing resin gears can have the slit G described above.

(8) β1 and β2 are equal (β1=β2). In other words, the twist angle β1 of the tooth 11 of the first teeth section 10 and the twist angle β2 of the tooth 21 of the second teeth section 20 are the same.

The resin gear 1 of the invention can achieve the effects described in (1) and (2) above. In addition, the resin gear 1 according to the embodiment can also achieve the effects described in (3) to (8).

According to each embodiment below, components that are the same as those of the resin gear 1 according to the first embodiment are given the same reference numbers. Explanations that are the same as that according to the first embodiment will be omitted.

### Second Embodiment

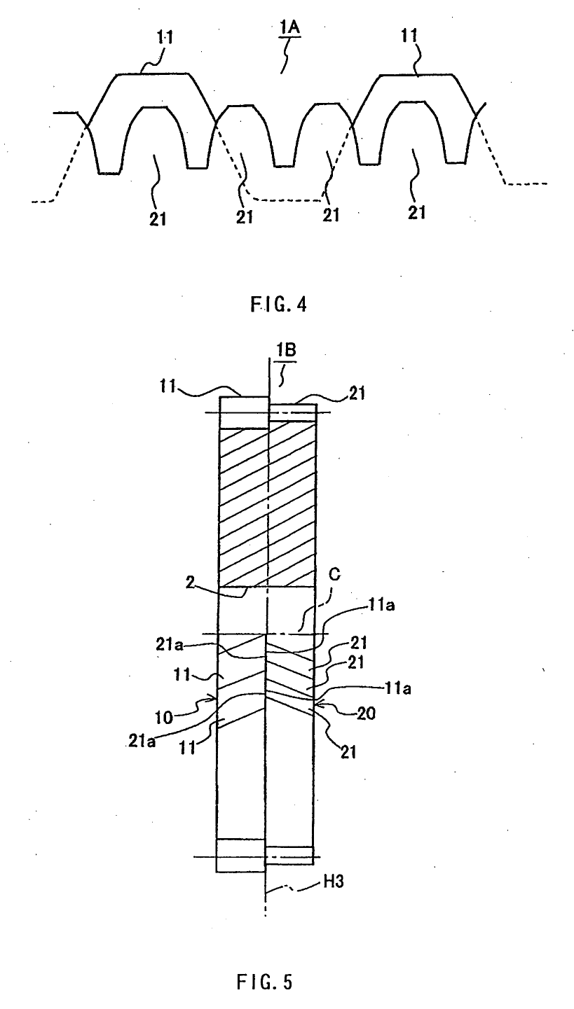

FIG. 4 is a schematic diagram of the teeth 11 and the teeth 21 of a resin gear 1A according to a second embodiment, viewed from a rear side. According to the second embodiment, n in m1=nm2 is an odd number, rather than of (5) according to the first embodiment. As a result, two or more teeth 21 of the second teeth section 20 can be disposed between two adjacent teeth 11 of the first teeth section 10.

### Third Embodiment

FIG. 5 is a side view of a resin gear 1B according to a third embodiment. According to the third embodiment, the ring-shaped slit G is not provided, rather than (7) according to the first embodiment. In other words, the end surface 11a on the tooth width direction center section side of the tooth 11 of the first teeth section 10 and the end surface 21a on the tooth width direction center section side of the tooth 21 of the second teeth section 20 are positioned on a same plane H3. As a result, taking into consideration the end surfaces 11a of a plurality of teeth 11 of the first teeth section 10 and the end surfaces 21a of a plurality of teeth 21 of the second teeth section 20, sections at which the end section 11a and the end section 21a are in contact and sections at which the end section 11a and the section 21a are not in contact can be provided. According to the third embodiment, because the slit G is not formed, the dimensions of the resin gear 1 in the tooth width direction can be shortened. The end surfaces 11a on the tooth width direction center side of the teeth 11 of the first teeth section 10 comes into contact with alternate end surfaces 21a on the tooth width direction center side of the teeth 21 of the second teeth section 20. As a result, compared to when the end surfaces are not in contact, the rigidity (strength) of each tooth 11 and tooth 21 can be increased.

### Fourth Embodiment

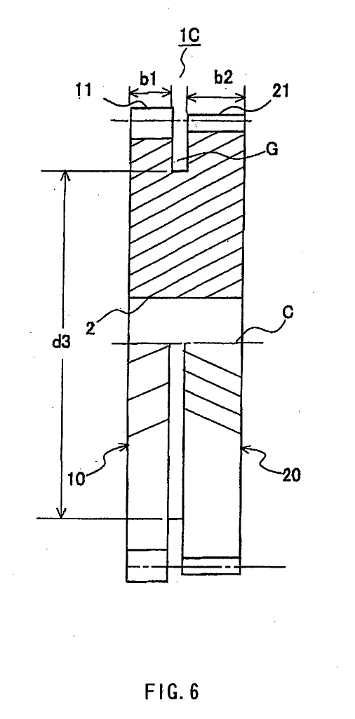

FIG. 6 is a side view of a resin gear 1C according to a fourth embodiment. According to the fourth embodiment, in place of (6) according to the first embodiment, b1 does not equal b2 (b1≠b2). In other words, the tooth width b1 of the tooth 11 of the first teeth section 10 and the tooth width b2 of the tooth 21 of the second teeth section 20 differ. When the tooth width b1 of the first teeth section 10 is fixed, the contact ratio on the second teeth section 20 side can be changed by changing the tooth width b2 of the second teeth section 20. When the tooth width b2 of the second teeth section 20 is increased, as described above, an overlap ratio increases in proportion to the tooth width b2. Therefore, quietness and smoothness can be enhanced. Transmission load can be increased.

According to the first embodiment to the fourth embodiment, above, examples in which the resin gear 1 and the resin gears 1A to 1C are formed integrally are described. However, the invention is not limited thereto. For example, after the first teeth section 10 and the second teeth section 20 are formed separately, the separate first teeth section 10 and second teeth section 20 can be joined and integrated.

### INDUSTRIAL APPLICABILITY

The resin gear of the present invention is widely used in power transmission mechanisms in image forming devices such as copiers, printers, and facsimile machines, automobile components, precision machinery, electronic devices, and the like requiring quiet, high-speed rotation, high-load power transmission, reduction in weight, and reduction in product price.

What is claimed is:

1. A resin gear including a first teeth section formed into a spiral and a second teeth section formed into a spiral having an opposite twist direction from the first teeth section, wherein:
a diameter of a pitch-circle of the first teeth section and a diameter of a pitch-circle of the second teeth section are the same; and
a module of the first teeth section and a module of a second teeth section differ.

2. The resin gear according to claim 1, wherein the module of the first teeth section is an integral multiple of the module of the second teeth section.

3. The resin gear according to claim 2, wherein:
a position in a circumferential direction of a center in a tooth thickness direction on an end surface positioned on the tooth width direction center section side, between two end surfaces of a tooth of the first teeth section, matches a position in a circumferential direction of a center in a tooth thickness direction on an end surface positioned on the tooth width direction center section side, between two end surfaces of a tooth of the second teeth section.

4. The resin gear according to claim 3, wherein the module of the first teeth section is an even number multiple of the module of the second teeth section.

5. The resin gear according to claim 3, wherein the module of the first teeth section is an odd number multiple of the module of the second teeth section.

6. The resin gear according to any one of claims 3 to 5, wherein:
the end surface on the tooth width direction center section side of the tooth of the first teeth section and the end surface on the tooth width direction center section side of the tooth of the second teeth section are on a same plane.

7. The resin gear according to any one of claims 3 to 5, wherein:
the end surface on the tooth width direction center section side of the tooth of the first teeth section and the end surface on the tooth width direction center section side of the tooth of the second teeth section are each in different positions in the tooth width direction and on two different planes perpendicular in the tooth width direction.

8. The resin gear according to claim 1, wherein the tooth width of the tooth of the first teeth section and the tooth width of the tooth of the second teeth section differ.
